(19) United States
(12) Patent Application Publication
(10) Pub. No.: US 2024/0399762 A1
(43) Pub. Date: Dec. 5, 2024

(54) IMAGE FORMING APPARATUS

(71) Applicant: Toshiba Tec Kabushiki Kaisha, Tokyo (JP)

(72) Inventor: Takahiro KOJIMA, Mishima Shizuoka (JP)

(73) Assignee: Toshiba Tec Kabushiki Kaisha, Tokyo (JP)

(21) Appl. No.: 18/642,666

(22) Filed: Apr. 22, 2024

(30) Foreign Application Priority Data
May 31, 2023 (JP) 2023-089823

(51) Int. Cl. B41J 2/47; G03G 15/00; G03G 15/043

(52) U.S. Cl. CPC B41J 2/471; G03G 15/0435; G03G 15/5079; G03G 15/55

(57) ABSTRACT

An image forming apparatus configured to scan laser light on a photoconductive body with a polygon mirror rotated by a polygon mirror motor includes a first determining unit, a second determining unit, and a storage unit. After the polygon mirror motor is started and shifts to steady rotation in a target rotating speed range, the first determining unit determines, repeatedly at a regular interval, whether rotating speed of the polygon mirror motor is within the target rotating speed range. If the rotating speed is outside the target rotating speed range a specified continuous number of times, the second determining unit determines that failure of the polygon mirror motor occurred. If the rotating speed returns from the outside to within the target rotating speed range a number of times less than the specified continuous number of times, the storage unit stores the number of times.

### CROSS-REFERENCE TO RELATED APPLICATION

This application is based upon and claims the benefit of priority from Japanese Patent Application No. 2023-089823, filed on May 31, 2023, the entire contents of which are incorporated herein by reference.

### FIELD

Embodiments described herein relate generally to an image forming apparatus.

### BACKGROUND

An image forming apparatus placed in a workplace includes a printer that forms a visible image corresponding to image data on paper. As the image forming apparatus, a digital multi-function peripheral (MFP) including, in addition to such a printer, a scanner that acquires a character, an illustration, or a photograph on a reading target object as brightness and darkness of light and generates image data corresponding to the brightness and darkness is also widely used. As the printer of the image forming apparatus, an electrophotographic printer is widely used. The electrophotographic printer includes an exposure device including a plurality of laser light sources and an optical system such as a polygon mirror. The exposure device irradiates a photoconductive drum with laser light controlled according to image data to thereby form a latent image on the photoconductive drum. The image forming apparatus visualizes the latent image with a developing material (a developer) to obtain a visible image. The image forming apparatus once moves the visible image to a transfer belt and further moves the visible image moved to the transfer belt onto paper. The image forming apparatus fixes the visible image moved onto the paper on the paper with a fixing device.

Power and an ON signal from the outside is supplied to a polygon mirror motor that drives to rotate the polygon mirror of the exposure device. A clock signal and the like from the inside or the outside are supplied to the polygon mirror motor to control rotating speed of the polygon mirror motor. The polygon mirror motor starts rotating and the rotating speed increases if the ON signal is input. If the rotating speed reaches rotating speed corresponding to the clock, the polygon mirror motor enters steady rotation and outputs a rotation synchronous signal.

In the related art, in detection of an abnormality of the polygon mirror motor, after the polygon mirror motor enters the steady rotation, the image forming apparatus detects, at a regular interval, the rotation synchronous signal output from the polygon mirror motor. If the rotation synchronous signal is not obtained, the image forming apparatus determines that an abnormality of the polygon mirror motor occurred, displays the abnormality on a display unit of an operation panel included in the image forming apparatus, and stops the operation of the image forming apparatus. The image forming apparatus cannot be used until repairing such as replacement of the polygon mirror is completed.

### BRIEF DESCRIPTION OF THE DRAWINGS

FIG. 1 is a schematic configuration diagram of a printing system including an image forming apparatus according to at lease one embodiment;

FIG. 2 is a sectional view schematically illustrating a configuration example of the image forming apparatus;

FIG. 3 is a diagram illustrating a configuration example of an exposure unit used in the image forming apparatus;

FIG. 4 is a sectional view illustrating a configuration example of the exposure unit disposed in the image forming apparatus;

FIG. 5 is a block diagram illustrating a configuration example of a control system in the image forming apparatus;

FIG. 6 is a block diagram illustrating a configuration example of a nonvolatile memory of a printer in the image forming apparatus;

FIG. 7 is a diagram illustrating a first portion of a series of flowcharts for explaining an operation example of diagnosis operation of a polygon mirror motor in the image forming apparatus;

FIG. 8 is a diagram illustrating a second portion of the series of flowcharts for explaining the operation example of the diagnosis operation of the polygon mirror motor;

FIG. 9 is a time chart illustrating a relation among motor rotating speed, a rotation synchronous signal, and synchronization detection control in the case in which the polygon mirror motor in the image forming apparatus is normal;

FIG. 10 a time chart illustrating a relation among motor rotating speed, a rotation synchronous signal, synchronization detection signal control, a count value of a first counter, and a count value of a second counter in the case in which the polygon mirror broke down; and

FIG. 11 is a time chart illustrating a relation among motor rotating speed, a rotation synchronous signal, synchronization detection signal control, a count value of the first counter, and a count value of the second counter in the case in which the polygon mirror motor does not completely break down but there is a sign of failure.

### DETAILED DESCRIPTION

An object of embodiments is to provide an image forming apparatus capable of predicting failure at a point in time before a polygon mirror motor completely breaks down.

In one embodiment, an image forming apparatus is an image forming apparatus that scans laser light on a photoconductive body with a polygon mirror rotated by a polygon mirror motor and performs image formation, the image forming apparatus including a first determining unit, a second determining unit, and a storage unit. After the polygon mirror motor is started and shifts to steady rotation in a target rotating speed range, the first determining unit determines, repeatedly at a regular interval, whether rotating speed of the polygon mirror motor is within the target rotating speed range. If the rotating speed of the polygon mirror motor is outside the target rotating speed range a specified continuous number of times, the second determining unit determines that failure of the polygon mirror motor occurred. If the rotating speed of the polygon mirror motor returns from the outside of the target rotating speed range to within the target rotating speed range a number of times less than the specified continuous number of times, the storage unit stores the number of times.

An image forming apparatus according to an embodiment is explained below with reference to the drawings. Note that, in the drawings referred to in the following explanation of the embodiment, scales of sections are changed as appropriate. In the drawings referred to in the following explanation of the embodiment, components are omitted as appropriate for explanation.

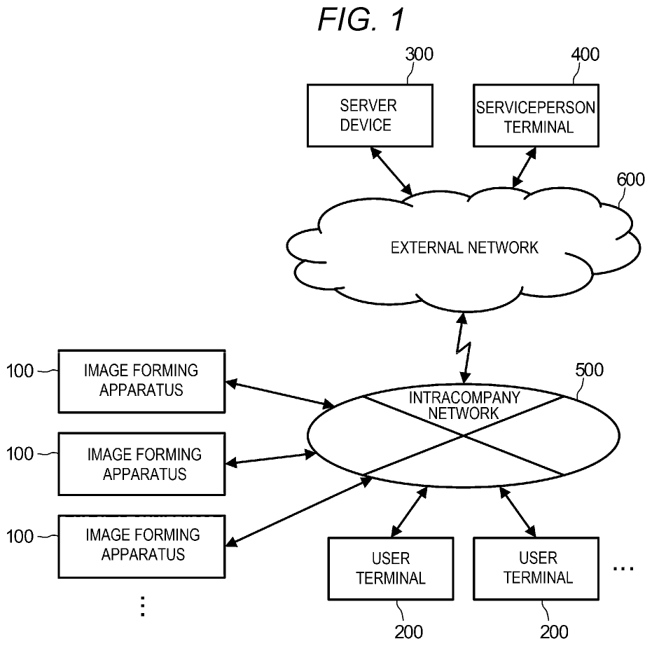

FIG. 1 is a schematic configuration diagram of a printing system including a plurality of image forming apparatuses 100 according to the embodiment. The printing system further includes a plurality of user terminals 200, a server apparatus 300, and a serviceperson terminal 400. The image forming apparatuses 100 are placed in a workplace and can be communicably connected to, via an intracompany network 500 such as a LAN (Local Area Network), the user terminals 200 disposed in the same workplace. The connection may be wired connection or may be wireless connection. The intracompany network 500 is connected to an external network 600 such as the Internet. The server apparatus 300 and the serviceperson terminal 400 are connected to the external network 600. Consequently, the image forming apparatuses 100 can be communicably connected to the server apparatus 300 via the intracompany network 500 and the external network 600.

The user terminals 200 are information processing devices such as personal computers (PCs), smartphones, tablet terminals, and digital cameras that instruct any ones of the image forming apparatuses 100 to perform printing. Note that the user terminals 200 may be communicably connected to the image forming apparatuses 100 via the external network 600 and the intracompany network 500. That is, the user terminals 200 may be present outside the workplace where the image forming apparatuses 100 are placed. The user terminals 200 may be directly connected to the image forming apparatuses 100 not via the external network 600 and the intracompany network 500, that is, may be locally connected to the image forming apparatuses 100. The local connection may also be wired connection or may be wireless connection.

The server apparatus 300 is a computer apparatus that a management company, which undertakes maintenance and inspection of the image forming apparatuses 100, directly operates or operates by outsourcing the operation to a service provision company. The server apparatus 300 acquires data indicating operation statuses of the image forming apparatuses 100 periodically or according to necessity or acquires notification data such as alerts transmitted from the image forming apparatuses 100. The server apparatus 300 discriminates, based on the acquired data, necessity of inspection or repairing of the image forming apparatuses 100. If the image forming apparatus 100 requiring inspection or repairing is present, the server apparatus 300 can send a serviceperson to inspection or repairing of the image forming apparatus 100 by transmitting information for specifying the image forming apparatus 100 to the serviceperson terminal 400.

The serviceperson terminal 400 is an information processing device such as a smartphone or a tablet terminal carried by a serviceperson who inspects and repairs the image forming apparatus 100. Note that, in FIG. 1, only one serviceperson terminal 400 is illustrated. However, the printing system can include a plurality of serviceperson terminals 400. In that case, the server apparatus 300 can assign, based on information such as position information of servicepersons obtained by using a position detecting function included in the serviceperson terminals 400 and availabilities of the servicepersons, an appropriate serviceperson to the image forming apparatus 100 requiring inspection and repairing.

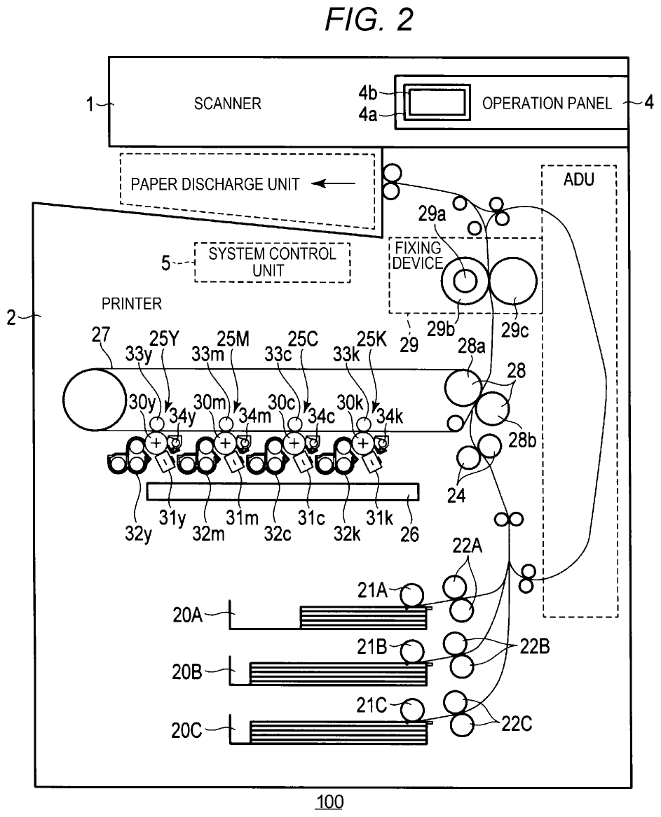

FIG. 2 is a sectional view schematically illustrating a configuration example of the image forming apparatus 100 according to the embodiment. The image forming apparatus 100 illustrated in FIG. 2 is an MFP and includes a scanner 1, a printer 2, an operation panel 4, and a system control unit 5.

The scanner 1 is a device that reads an image of an original document and converts the image into image data. The scanner 1 is configured by, for example, a CCD (Charge Coupled Device) line sensor that converts an image on a reading surface of an original document into image data. The scanner 1 may have a function of scanning an original document placed on an original table glass. The scanner 1 may have a function of reading an image of an original document conveyed by an ADF (Auto Document Feeder). The scanner 1 is installed in, for example, a main body upper part of the MFP. The scanner 1 is controlled by the system control unit 5. The scanner 1 outputs the image data of the original document to the system control unit 5.

The printer 2 is an electrophotographic printer. The printer 2 forms an image on paper serving as a recording medium. The printer 2 has a color printing function for printing a color image on paper and a monochrome printing function for printing a monochrome (for example, black) image on paper. The printer 2 forms a color image using toners of a plurality of colors (for example, three colors of yellow (Y), cyan (C), magenta (M)). The printer 2 forms a monochrome image using a monochrome (for example, black (K)) toner.

In the configuration example illustrated in FIG. 2, the printer 2 includes paper feeding cassettes 20 (20A, 20B, and 20C). The paper feeding cassettes 20 are paper feeding units that feed paper on which an image is printed. The printer 2 may include a manual feed tray as a paper feeding unit. For example, the paper feeding cassettes 20A, 20B, and 20C are provided in a state in which the paper feeding cassettes 20A, 20B, and 20C are detachably attachable to a lower part of an MFP main body. Each of the paper feeding cassettes 20A, 20B, and 20C stores paper of a type (for example, a size and paper quality) set for the paper feeding cassette.

The paper feeding cassettes 20A, 20B, and 20C respectively include pickup rollers 21A, 21B, and 21C. The pickup rollers 21A, 21B, and 21C pick up paper piece by piece from the paper feeding cassettes 20A, 20B, and 20C. The pickup rollers 21A, 21B, and 21C supply the picked-up paper to a conveying path (a conveying unit 22) configured from a plurality of conveying rollers 22A, 22B, and 22C and the like.

The conveying unit 22 conveys paper in the printer 2. For example, the conveying unit 22 conveys the paper picked up by the pickup rollers 21A, 21B, and 21C to a registration roller 24. The registration roller 24 conveys the paper to a transfer position at timing when an image is transferred from a transfer belt 27 to the paper. The conveying unit 22 conveys the paper having passed the registration roller 24 to the transfer position. The conveying unit 22 conveys the paper having passed the transfer position from the transfer position to a fixing device 29. The conveying unit 22 conveys the paper having passed the fixing device 29 to a paper discharge unit or an automatic double-sided unit (ADU).

Image forming units 25 (25Y, 25M, 25C, and 25K) form images to be transferred to paper. In the configuration example illustrated in FIG. 2, the image forming unit 25Y forms an image with the yellow toner. The image forming unit 25M forms an image with the magenta toner. The image forming unit 25C forms an image with the cyan toner. The image forming unit 25K forms an image with the black toner.

The image forming units 25 (25Y, 25M, 25C, and 25K) include photoconductive drums 30 (30y, 30m, 30c, and 30k), chargers 31 (31y, 31m, 31c, and 31k), developing devices 32 (32y, 32m, 32c, and 32k), transfer rollers 33 (33y, 33m, 33c, and 33k), and cleaners 34 (34y, 34m, 34c, and 34k).

The photoconductive drums 30 are image bearing bodies on which electrostatic latent images are formed. The photoconductive drums 30 are rotated by rotating shafts. The chargers 31 charge the surfaces of the photoconductive drums 30 to predetermined potential. The chargers 31 include not-illustrated grids for adjusting charging outputs to the photoconductive drums 30. The developing devices 32 develop, with toners, the electrostatic latent images formed on the photoconductive drums 30. The transfer rollers 33 transfer toner images developed on the photoconductive drums 30 to the transfer belt 27. The cleaners 34 clean the surfaces of the photoconductive drums 30 after the transfer.

An exposing unit 26 forms electrostatic latent images on the photoconductive drums 30 of the image forming units 25 (25Y, 25M, 25C, and 25K) with laser light. The exposing unit 26 irradiates, via an optical system such as a polygon mirror, the photoconductive drums 30 with laser light controlled according to image data. The laser light from the exposing unit 26 forms electrostatic latent images on the surfaces of the photoconductive drums 30. The exposing unit 26 controls the laser light according to a control signal from the system control unit 5.

The image forming units 25 (25Y, 25M, 25C, and 25K) develop the electrostatic latent images formed on the photoconductive drums 30 by the developing devices 32. The developing devices 32 include developing containers including developing rollers. The developing containers store toners serving as each of color developers. The toners are charged by being agitated in the developing containers together with a carrier. A developing bias is applied to the developing rollers. The developing rollers to which the developing bias is applied supply the toners to the electrostatic latent images on the photoconductive drums 30. The electrostatic latent images on the photoconductive drums 30 are developed as toner images by the toners supplied to the electrostatic latent images.

The transfer belt 27 is an intermediate transfer body. Each of the image forming units 25 (25Y, 25M, 25C, and 25K) applies a primary transfer voltage to the transfer belt 27 with the transfer rollers 33 to transfer (primarily transfer) the toner images formed on the photoconductive drums 30 onto the transfer belt 27. For example, the image forming unit 25K transfers the toner image developed with the black toner by the developing device 32k onto the transfer belt 27 with the transfer roller 33k. If forming a color image, the image forming units 25Y, 25M, 25C, and 25K transfer the toner images developed with each of the color toners onto the transfer belt 27 one on top of another.

A transfer unit 28 transfers the toner images on the transfer belt 27 to paper in a secondary transfer position. The secondary transfer position is a position where the toner images on the transfer belt 27 are transferred to the paper. The secondary transfer position is a position where a support roller 28a and a secondary transfer roller 28b face.

The fixing device 29 fixes toner on paper. The fixing device 29 applies heat for fixing to the paper. In the example illustrated in FIG. 2, the fixing device 29 is configured by a heat roller 29b incorporating a heating unit 29a and a pressurizing roller 29c that is in contact with, in a pressurized state, a fixing belt heated by the heat roller 29b. The heating unit 29a only has to be a temperature controllable heater. For example, the heating unit 29a may be configured by a heater lamp such as a halogen lamp or may be a heater of an induction heating (IH) type. The heating unit 29a may be configured by a plurality of heaters. The fixing device 29 conveys the paper subjected to fixing processing to the paper discharge unit or the ADU.

The operation panel 4 is a user interface. The operation panel 4 includes various buttons and a display unit 4a including a touch panel 4b. The system control unit 5 controls content to be displayed on the display unit 4a of the operation panel 4. The display unit 4a functions as a notifying unit. The operation panel 4 outputs information input to the touch panel 4b or the buttons of the display unit 4a to the system control unit 5. A user designates an operation mode in the operation panel 4 or inputs information such as setting information to the operation panel 4.

Next, a configuration of the exposing unit 26 is explained.

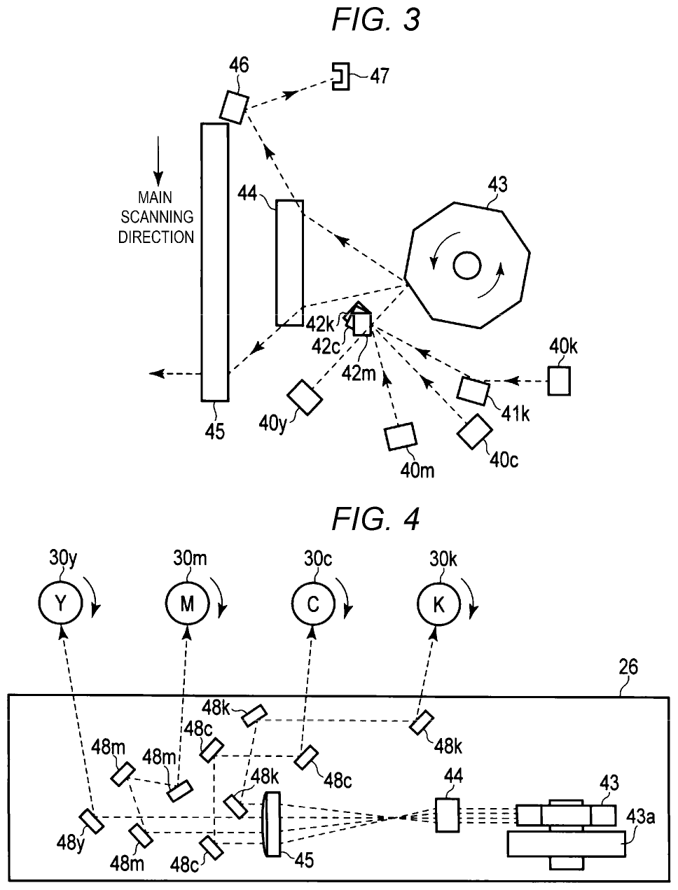

FIG. 3 is a diagram illustrating a configuration example of the exposing unit 26 used in the image forming apparatus 100. FIG. 4 is a sectional view illustrating a configuration example of the exposing unit 26 installed in the image forming apparatus 100.

The exposing unit 26 illustrated in FIGS. 3 and 4 includes exposure units for each of colors for forming images. In the image forming apparatus 100 that forms a color image illustrated in FIG. 2, the exposing unit 26 includes exposure units for each of colors for forming the color image. Note that, in an image forming apparatus that forms only a monochrome image, the exposing unit 26 only has to include one exposure unit for forming the monochrome image.

The exposing unit 26 illustrated in FIGS. 3 and 4 includes exposure units for each of colors of yellow, magenta, cyan, and black and a beam detect (BD) detecting unit. The exposure units for each of the colors include laser units 40 (40y, 40m, 40c, and 40k) and optical systems. The laser units 40 include a plurality of light emitting elements. For example, the laser units 40 are configured by laser arrays obtained by arraying a plurality of laser diodes (LDs). The optical systems configuring the exposure units for each of the colors include a mirror 41k, mirrors 42 (42m, 42c, and 42k), a polygon mirror 43, lenses 44 and 45, and mirror groups 48 (48y, 48m, 48c, and 48k).

The exposure unit for yellow includes the laser unit 40y, the polygon mirror 43, the lenses 44 and 45, and the mirror group 48y. The laser unit 40y emits laser light for forming a yellow image. The polygon mirror 43, the lenses 44 and 45, and the mirror group 48y are optical systems for guiding the laser light emitted by the laser unit 40y onto the photoconductive drum 30y. The polygon mirror 43 is rotated by a polygon mirror motor 43a. The polygon mirror 43 rotates to thereby scan the laser light in a main scanning direction on the photoconductive drum 30y. The main scanning direction is the direction of a rotation axis of the photoconductive drum 30y. A scanning position of the laser light emitted by the laser unit 40y is moved in a sub-scanning direction on the photoconductive drum 30y by the rotating polygon mirror 43. The sub-scanning direction is a direction orthogonal to the main scanning direction.

The exposure unit for magenta includes the laser unit 40m, the mirror 42m, the polygon mirror 43, the lenses 44 and 45, and the mirror group 48m. The laser unit 40m emits laser light for forming a magenta image. The polygon mirror 43, the lenses 44 and 45, and the mirror group 48m are optical systems for guiding the laser light emitted by the laser unit 40m onto the photoconductive drum 30m. The polygon mirror 43 is rotated by the polygon mirror motor 43a. The polygon mirror 43 rotates to thereby scan the laser light in the main scanning direction on the photoconductive drum 30m. The main scanning direction is the direction of a rotation axis of the photoconductive drum 30m. A scanning position of the laser light emitted by the laser unit 40m is moved in the sub-scanning direction on the photoconductive drum 30m by the rotating polygon mirror 43. The sub-scanning direction is the direction orthogonal to the main scanning direction.

The exposure unit for cyan includes the laser unit 40c, the mirror 42c, the polygon mirror 43, the lenses 44 and 45, and the mirror group 48c. The laser unit 40c emits laser light for forming a cyan image. The polygon mirror 43, the lenses 44 and 45, and the mirror group 48c are optical systems for guiding the laser light emitted by the laser unit 40c onto the photoconductive drum 30c. The polygon mirror 43 is rotated by the polygon mirror motor 43a. The polygon mirror 43 rotates to thereby scan the laser light in the main scanning direction on the photoconductive drum 30c. The main scanning direction is the direction of a rotation axis of the photoconductive drum 30c. A scanning position of the laser light emitted by the laser unit 40c is moved in the sub-scanning direction on the photoconductive drum 30c by the rotating polygon mirror 43. The sub-scanning direction is the direction orthogonal to the main scanning direction.

The exposure unit for black includes the laser unit 40k, the mirrors 41k and 42k, the polygon mirror 43, the lenses 44 and 45, and the mirror group 48k. The laser unit 40k emits laser light for forming a black image. The polygon mirror 43, the lenses 44 and 45, and the mirror group 48k are optical systems for guiding the laser light emitted by the laser unit 40k onto the photoconductive drum 30k. The polygon mirror 43 is rotated by the polygon mirror motor 43a. The polygon mirror 43 rotates to thereby scan the laser light in the main scanning direction on the photoconductive drum 30k. The main scanning direction is the direction of a rotation axis of the photoconductive drum 30k. A scanning position of the laser light emitted by the laser unit 40k is moved in the sub-scanning direction on the photoconductive drum 30k by the rotating polygon mirror 43. The sub-scanning direction is the direction orthogonal to the main scanning direction.

The BD detecting unit of the exposing unit 26 includes a mirror 46 and a BD sensor 47. The mirror 46 guides the laser light scanned by the polygon mirror 43 to the BD sensor 47. The BD sensor 47 detects laser light from any one light source in the laser units 40. The BD sensor 47 detects the laser light as a signal (a BD signal or a reference signal) serving as a reference for scanning in the main scanning direction. The BD sensor 47 is set on a scanning line on which laser light from an LD (a reference light emitting element) that should be detected is scanned. That is, the BD sensor 47 detects that the laser light is in a reference position in the main scanning direction. In LDs of each of the laser units 40, emission of laser light is controlled based on the BD signal detected by the BD sensor 47.

Next, a configuration of a control system of the image forming apparatus 100 is explained.

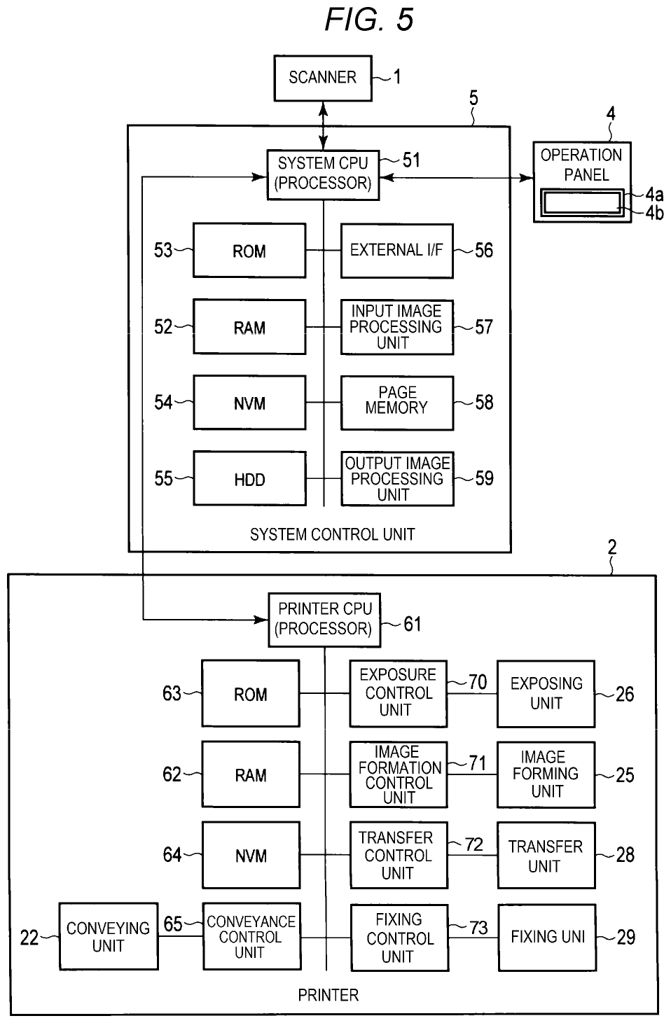

FIG. 5 is a block diagram schematically illustrating a configuration example of control systems in the system control unit 5 and the printer 2 of the image forming apparatus 100.

In this configuration example, the system control unit 5 includes a system CPU (Central Processing Unit) 51, which is a processor, a RAM (Randon Access Memory) 52, a ROM (Read Only Memory) 53, a nonvolatile memory (in FIG. 5, described as NVM (Non-volatile Memory)) 54, a HDD (Hard Disk Drive) 55, an external interface (in FIG. 5, described as I/F) 56, an input image processing unit 57, a page memory 58, and an output image processing unit 59.

The system CPU 51 is a control unit that collectively controls each of the units of the image forming apparatus 100. The system CPU 51 is a processor that executes a program to thereby implement processing. The system CPU 51 is connected to each of the units in the system control unit 5 via a system bus. The system CPU 51 is also connected to the scanner 1, the printer 2, the operation panel 4, and the like via the system bus. The system CPU 51 outputs operation instructions to each of the units and acquires various kinds of information from each of the units by bidirectional communication with the scanner 1, the printer 2, and the operation panel 4.

Note that a CPU, which is a processor configuring the control unit, may be a multicore and multithread CPU and can execute a plurality of kinds of processing in parallel. The processor is not limited to the CPU and may be an MPU (micro processing unit). Further, the processor may be implemented by other various forms including integrated circuits such as an ASIC (Application Specific Integrated Circuit), a GPU (Graphics Processing Unit), an FPGA (field-programmable gate array), a DSP (Digital Signal processor), an SoC (system on a chip), and a PLD (programmable logic device). The processor may be a combination of a plurality of forms among these forms.

The RAM 52 is configured by a volatile memory. The RAM 52 functions as a working memory or a buffer memory. The ROM 53 is an un-rewritable nonvolatile memory that stores programs, control data, and the like. The system CPU 51 executes the programs stored in the ROM 53 (or the nonvolatile memory 54 or the HDD 55) while using the RAM 52 to thereby implement various kinds of processing. For example, the system CPU 51 executes the programs to thereby implement a function of instructing execution of printing and a function of prohibiting printing.

The nonvolatile memory 54 is a rewritable nonvolatile memory. The nonvolatile memory 54 stores a control program to be executed by the system CPU 51 and control data. The nonvolatile memory 54 stores various kinds of setting information, processing conditions, and the like. For example, the nonvolatile memory 54 stores setting information for the paper feeding cassettes (the paper feeding units).

The HDD 55 is a large-capacity storage device. The HDD 55 stores image data, various kinds of operation history information, and the like. The HDD 55 may store a control program, control data, and the like. The HDD 55 may store setting information, processing conditions, and the like.

The external interface 56 is an interface for communicating with external apparatuses. For example, the external interface 56 receives a printing job from the user terminal 200, which is an external apparatus, and transmits data to the server apparatus 300, which is an external apparatus. The external interface 56 only has to be an interface that performs data communication with the external apparatuses.

The input image processing unit 57 subjects image data read by the scanner 1 to image processing. The input image processing unit 57 has functions of shading correction processing, gradation conversion processing, interline correction processing, and compression and extension processing. The input image processing unit 57 stores the image data subjected to the image processing in the page memory 58.

The page memory 58 is a memory for loading image data. For example, the page memory 58 stores image data obtained by the input image processing unit 57 performing image processing on the image data read by the scanner 1. The page memory 58 may store image data included in the printing job acquired by the external interface 56.

The output image processing unit 59 generates image data for printing that the printer 2 prints on paper. The output image processing unit 59 performs image processing for converting the image data stored in the page memory 58 into the image data for printing. The output image processing unit 59 transmits the image data subjected to the image processing to the printer 2.

Next, a configuration example of the control system in the printer 2 is explained.

In the configuration example illustrated in FIG. 5, the printer 2 includes, as components of a control system, a printer CPU 61, a RAM 62, a ROM 63, a nonvolatile memory (NVM) 64, a conveyance control unit 65, an exposure control unit 70, an image formation control unit 71, a transfer control unit 72, and a fixing control unit 73.

The printer CPU 61 controls the entire printer 2. The printer CPU 61 is a processor that executes a program to thereby implement processing. Note that the processor is not limited to the CPU and may be implemented in other various forms including integrated circuits such as an MPU, an ASIC, a GPU, an FPGA, a DSP, an SoC, and a PLD. The processor may be a combination of a plurality of forms among these forms. The printer CPU 61 is connected to each of the units in the printer 2 via a system bus or the like. The printer CPU 61 outputs operation instructions to each of the units in the printer 2 according to an operation instruction from the system CPU 51. The printer CPU 61 notifies information indicating a processing status in the printer 2 to the system CPU 51.

The RAM 62 is configured by a volatile memory. The RAM 62 functions as a working memory or a buffer memory. The ROM 63 is an un-rewritable nonvolatile memory that stores programs and control data. The printer CPU 61 executes the programs stored in the ROM 63 (or the nonvolatile memory 64) while using the RAM 62 to thereby implement various kinds of processing.

The nonvolatile memory 64 is a rewritable nonvolatile memory. For example, the nonvolatile memory 64 stores a control program to be executed by the printer CPU 61 and control data and history data generated by the printer CPU 61 executing the control program. The nonvolatile memory 64 may store setting information, processing conditions, and the like.

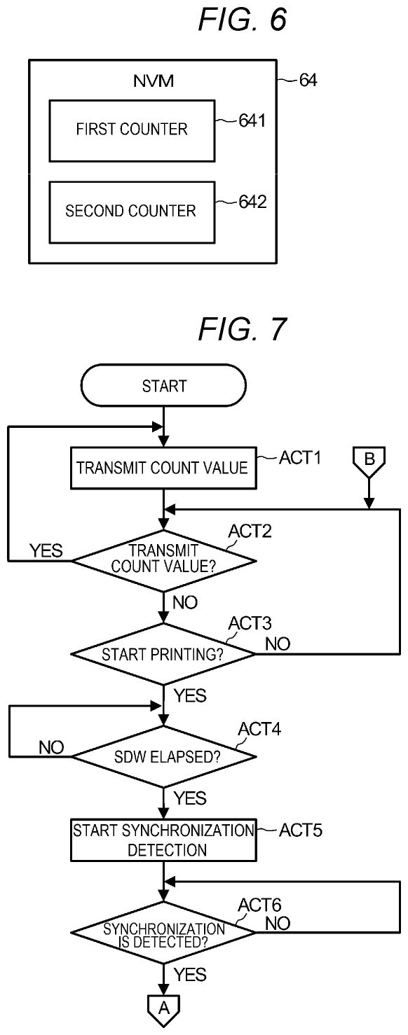

FIG. 6 is a block diagram illustrating a configuration example of the nonvolatile memory 64. In this embodiment, the nonvolatile memory 64 can include two counters, that is, a first counter 641 and a second counter 642. The first counter 641 is a counter for, if the polygon mirror motor 43a is started and shifts to steady rotation and, thereafter, deviates from a state of the steady rotation, counting the length of a period of the deviation. The second counter 642 is a counter for counting the number of times the polygon mirror motor 43a returns to the steady rotation state after deviating from the steady rotation state.

The conveyance control unit 65 controls paper conveyance in the printer 2. The conveyance control unit 65 controls driving of the pickup rollers 21, the conveying rollers 22A, 22B, and 22C of the conveying unit 22, and the like. The conveyance control unit 65 controls, according to an operation instruction from the printer CPU 61, the driving of the conveying rollers 22A, 22B, and 22C functioning as the conveying unit 22 in the printer 2. For example, the printer CPU 61 instructs, according to an instruction to start printing from the system control unit 5, the conveyance control unit 65 to perform paper conveyance control.

The exposure control unit 70 controls the exposing unit 26. The exposure control unit 70 forms electrostatic latent images on the photoconductive drums 30 (30y, 30m, 30c, and 30k) of each of the image forming units 25 (25Y, 25M, 25C, and 25K) with the exposing unit 26 according to an operation instruction from the printer CPU 61. For example, the exposure control unit 70 controls, according to image data for which execution of printing execution is instructed to the printer CPU 61, laser light with which the exposing unit 26 irradiates the photoconductive drums 30. For example, the exposure control unit 70 controls, based on a BD signal acquired from the exposing unit 26, scanning of laser light emitted by the laser units.

The image formation control unit 71 controls driving each of the image forming units 25 (25Y, 25M, 25C, and 25K). For example, the image formation control unit 71 charges the photoconductive drums 30 to predetermined potential with the chargers 31. The image formation control unit 71 develops, with the developing devices 32, electrostatic latent images formed on the photoconductive drums 30 after the charging processing using each of the color toners. The image formation control unit 71 controls a development bias or the like for the developing devices 32 to thereby control the concentration of the toners for development. The image formation control unit 71 transfers toner images developed on the photoconductive drums 30 onto the transfer belt 27 with the transfer rollers 33. The image formation control unit 71 cleans the surfaces of the photoconductive drums 30 after the transfer processing with the cleaners 34.

The transfer control unit 72 controls driving of the transfer unit 28, a transfer current, and the like. The transfer control unit 72 transfers, according to an operation instruction from the printer CPU 61, the toner images transferred onto the transfer belt 27 to paper with the transfer unit 28. The fixing control unit 73 controls driving of the fixing device 29. The fixing control unit 73 drives the heat roller 29b and the pressurizing roller 29c according to an operation instruction from the printer CPU 61. The fixing control unit 73 controls the heating unit 29a to thereby control a surface temperature of the heat roller 29b to a fixing temperature.

In the image forming apparatus 100 having the configuration explained above, if power is turned on by ON operation of a not-illustrated power switch, the system CPU 51 and the printer CPU 61 execute operations conforming to respective programs stored in the ROMs 53 and 63 (or the nonvolatile memories 54 and 64). For example, the system CPU 51 instructs, according to reception of a printing job from the user terminal 200, the printer 2 to perform printing indicated by the printing job or scans an original document with the scanner 1 according to a copy instruction to the touch panel 4b of the operation panel 4 by the user and instructs the printer 2 to print an image of the scanned original document. The printer CPU 61 of the printer 2 performs printing according to a printing instruction from the system CPU 51.

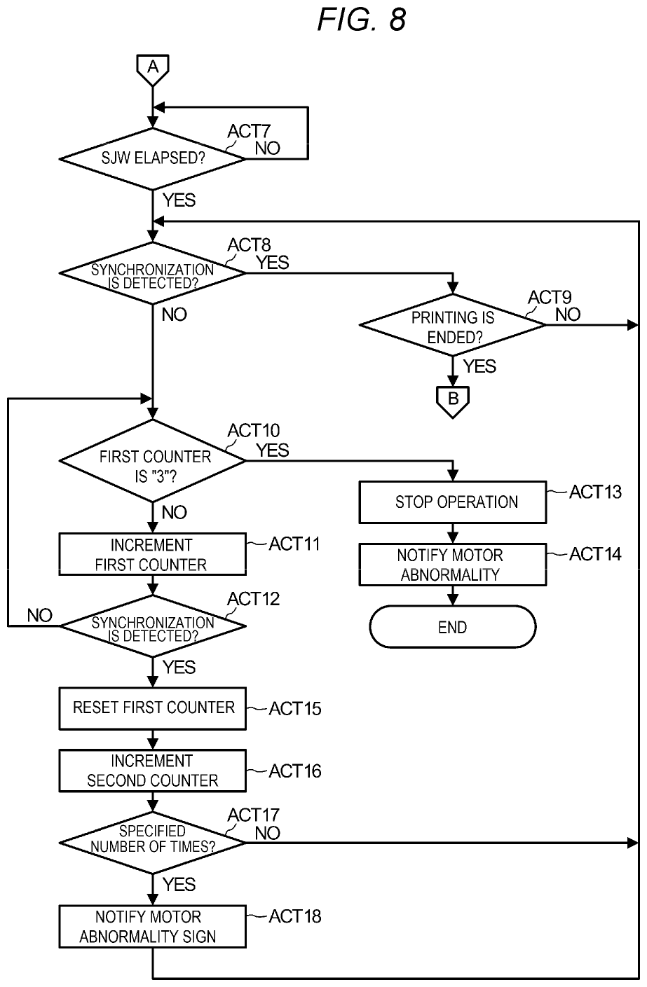

The printer CPU 61 executes operations for diagnosing defective parts of each of the units of the printer 2 in addition to this normal operation. As one of the diagnosis operations, there is a diagnosis operation for the polygon mirror motor 43a. FIGS. 7 and 8 are a series of flowcharts for explaining an operation example of the diagnosis operation for the polygon mirror motor 43a. Note that content of processing illustrated in FIGS. 7 and 8 and explained below is an example. Various kinds of processing capable of obtaining the same result can be used as appropriate. For example, if power is turned on according to ON operation of a power switch, the printer CPU 61 executes processing of the diagnosis operation based on a control program stored in the nonvolatile memory 64. Note that, unless particularly explained otherwise, the processing of the printer CPU 61 transitions to ACT(n+1) after ACT n (n is a natural number).

In ACT 1, the printer CPU 61 transmits a count value of the second counter 642 of the nonvolatile memory 64 to the server apparatus 300. Specifically, the printer CPU 61 reads the count value of the second counter 642 of the nonvolatile memory 64 and requests the system CPU 51 of the system control unit 5 to transmit the count value. According to the request, the system CPU 51 transmits the count value to the server apparatus 300 with the external interface 56.

In ACT 2, the printer CPU 61 determines whether to transmit the count value to the server apparatus 300. Specifically, the printer CPU 61 determines whether a read request for a count value was received from the system CPU 51. If receiving a transmission request for the count value from the server apparatus 300, the system CPU 51 requests the printer CPU 61 to read the count value. The printer CPU 61 shifts to the processing operation in ACT 1 explained above based on the determination that a read request for the count value was received, that is, the count value is transmitted to the server apparatus 300 (YES in ACT 2).

Based on the determination that a read request for the count value was not received, that is, the count value is not transmitted to the server apparatus 300 (NO in ACT 2), in ACT 3, the printer CPU 61 determines whether to start printing. Specifically, the printer CPU 61 determines whether a printing request from the system CPU 51 was received. The printer CPU 61 shifts to the processing operation in ACT 2 based on the determination not to start printing (NO in ACT 3).

Based on the determination to start printing (YES in ACT 3), the printer CPU 61 determines whether a synchronization detection standby period SDW elapsed.

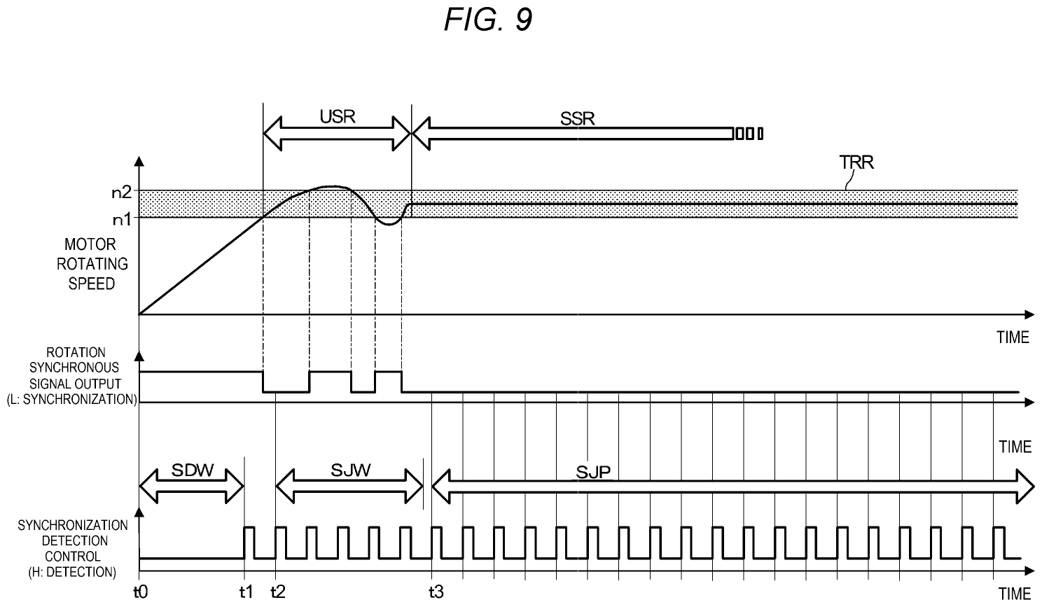

FIG. 9 is a time chart illustrating a relation among motor speed, a rotation synchronous signal, and synchronization detection control in the case in which the polygon mirror motor 43a is normal.

At time t10, which is a printing start time, a rotation ON signal is transmitted from the printer CPU 61 to the polygon mirror motor 43a of the exposing unit 26. According to the rotation ON signal, the polygon mirror motor 43a starts rotation. A target rotating speed range TRR is specified according to a clock supplied from the printer CPU 61 to the polygon mirror motor 43a or a clock provided on the inside of the polygon mirror motor 43a. If the rotating speed of the polygon mirror motor 43a rises and enters the target rotating speed range TRR, the polygon mirror motor 43a enters steady rotation. While the rotating speed of the polygon mirror motor 43a is within the target rotating speed range TRR, a rotation synchronous signal is transmitted from the polygon mirror motor 43a to the printer CPU 61. The printer CPU 61 detects the rotation synchronous signal and continues the printing operation.

However, it takes time until the rotating speed of the polygon mirror motor 43a reaches steady rotating speed after the polygon mirror motor 43a starts rotation. Therefore, a detection operation for synchronization in the printer CPU 61 is started after standby for time t1, which is a fixed time, rather than being immediately started after the rotation ON signal is output. A period of the standby until the time t1 is the synchronization detection standby period SDW.

Referring back to FIG. 8, based on the determination that the synchronization detection standby period SDW did not elapse (NO in ACT 4), the printer CPU 61 repeats the processing operation in ACT 4. That is, the printer CPU 61 continues the processing operation in ACT 4 until determining that the synchronization detection standby period SDW elapsed. It can be said that the printer CPU 61 waits for the synchronization detection standby period SDW to elapse.

Based on the determination at the time t1 that the synchronization detection standby period SDW elapsed (YES in ACT 4), in ACT 5, the printer CPU 61 starts a synchronization determination operation.

Basically, in synchronization detection control illustrated in FIG. 9, a high state is a period of synchronization detection and the printer CPU 61 determines, at rising timing to the high state, based on the rotation synchronous signal output from the polygon mirror motor 43a, whether the polygon mirror motor 43a is synchronized. Specifically, the printer CPU 61 determines whether the rotation synchronous signal transmitted from the polygon mirror motor 43a is in a low state. The printer CPU 61 carries out the synchronization determination operation at a predetermined regular interval. A time not erroneously detected such as approximately several seconds to thirty seconds is set as the regular interval and stored in the nonvolatile memory 64.

In ACT 6, if the time set as the regular interval comes, the printer CPU 61 determines whether synchronization of the polygon mirror motor 43a was detected. Specifically, the printer CPU 61 determines whether the rotation synchronous signal is output from the polygon mirror motor 43a, that is, the rotation synchronous signal is in the low state. Based on the determination that synchronization was not detected (NO in ACT 6), the printer CPU 61 repeats the processing operation in ACT 6. By continuing the processing operation in ACT 6 in this way, in every time set as the regular interval, the printer CPU 61 determines whether synchronization was detected. It can be said that the printer CPU 61 waits for the polygon mirror motor 43a to change to the synchronous state.

As illustrated in FIG. 9, at time t2 that is first synchronization determination timing after the rotating speed of the polygon mirror motor 43a reached the target rotating speed range TRR and the rotation synchronous signal changed to the low state, the printer CPU 61 determines that synchronization was detected.

Based on the determination that the synchronization was detected (YES in ACT 6), in ACT 7, the printer CPU 61 determines whether a synchronization determination standby period SJW elapsed. Based on the determination that the synchronization determination standby period SJW did not elapse (NO in ACT 7), the printer CPU 61 repeats the processing operation in ACT 7. That is, the printer CPU 61 continues the processing operation in ACT 7 until determining that the synchronization determination standby period SJW elapsed. It can be said that the printer CPU 61 waits for the synchronization determination standby period SJW to elapse.

Even if the rotating speed of the polygon mirror motor 43a enters the target rotating speed range TRR, the motor rotating speed does not immediately stabilize in a steady rotation region SSR. That is, as illustrated in FIG. 9, since rotation overshoots at the time when the motor rotating speed reaches the target rotating speed range TRR first, the rotating speed is adjusted to be maintained in the target rotating speed range TRR. In a period of the adjustment, the motor rotating speed increases and decreases and is unstable. After the rotation synchronous signal is turned on and off a plurality of times, finally, the steady rotation is continued. If the polygon mirror motor 43a is not steadily rotating, scanning speed of laser light rotated and scanned by the polygon mirror 43 becomes unstable and distortion occurs in printing. Therefore, the printer CPU 61 needs to wait for a time for a rotating speed unstable region USR after the rotating speed of the polygon mirror motor 43a reaches the target rotating speed range TRR and perform a printing operation. The rotating speed unstable region USR was calculated based on parameters such as the performance of the polygon mirror motor 43a and the weight of the polygon mirror 43 and stored in the nonvolatile memory 64 as setting information for each of the image forming apparatuses 100. For example, the rotating speed unstable region USR is approximately 0.5 second to 1.5 seconds.

The synchronization determination standby period SJW corresponds to the rotating speed unstable region USR. Based on the determination that the synchronization determination standby period SJW elapsed (YES in ACT 7), in ACT 8, if the time set as the regular interval comes, the printer CPU 61 determines whether synchronization of the polygon mirror motor 43a was detected.

In an example illustrated in FIG. 9, the printer CPU 61 detects synchronization at time t3 that is first rising timing to the high state of the synchronization detection control after the synchronization determination standby period SJW elapsed from the time t2. Based on the determination that synchronization was detected (YES in ACT 8), in ACT 9, the printer CPU 61 determines whether printing is ended, that is, the polygon mirror motor 43a is stopped. Based on the determination that the printing is not ended (NO in ACT 9), the printer CPU 61 shifts to the processing operation in ACT 8 explained above.

As explained above, if the synchronization of the polygon mirror motor 43a is detected after the elapse of the synchronization determination standby period SJW, the printer CPU 61 executes the synchronization detection at every time set as the regular interval, that is, at the regular interval until the printing ends. A period in which the synchronization detection is executed at the regular interval, the period being started from the synchronization detection timing after the elapse of the synchronization determination standby period SJW, is defined as synchronization determination period SJP.

Based on the determination that the printing in the synchronization determination period SJP is ended (YES in ACT 11), the printer CPU 61 shifts to the processing operation in ACT 2 explained above.

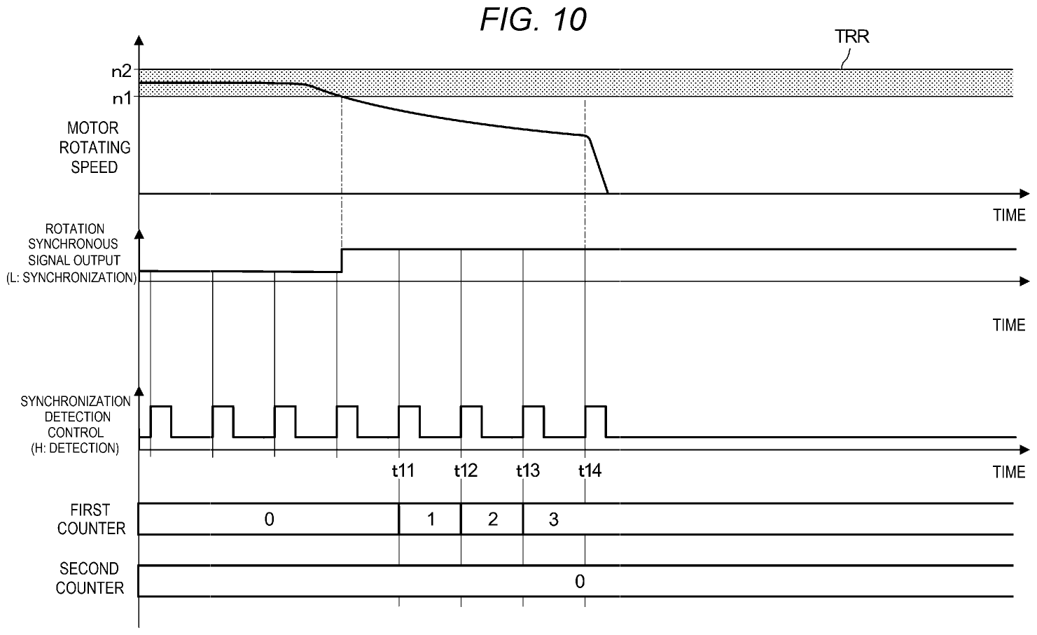

FIG. 10 is a time chart illustrating a relation among motor rotating speed, a rotation synchronous signal, synchronization detection signal control, a count value of the first counter 641, and a count value of the second counter 642 in the case in which the polygon mirror motor 43a broke down. If a defect occurs in the polygon mirror motor 43a, the motor rotating speed gradually decreases and deviates from the target rotating speed range TRR. In this case, as illustrated in FIG. 10, the rotation synchronous signal changes to the high state at a stage when the motor rotating speed deviates from the target rotating speed range TRR. At time t1l that is first synchronization determination timing after the rotation synchronous signal changes to the high state, the printer CPU 61 determines that synchronization is not detected.

Based on the determination that synchronization is not detected (YES in ACT 8), in ACT 10, the printer CPU 61 determines whether the count value of the first counter 641 of the nonvolatile memory 64 is a default value, in this example, “3”. Here, the count value of the first counter 641 is “0” as an initial value. Accordingly, at a point in time of the time t1l, the printer CPU 61 determines that the count value of the first counter 641 is not the default value “3”.

Based on the determination that the count value of the first counter 641 is not the default value “3” (NO in Act 10), in ACT 11, the printer CPU 61 increments the count value of the first counter 641. Consequently, the count value of the first counter 641 increases from “0” to “1”.

In ACT 12, if the time set as the regular interval comes, that is, at time t12, the printer CPU 61 determines whether synchronization of the polygon mirror motor 43a was detected. Based on the determination that synchronization was not detected (NO in ACT 12), the printer CPU 61 shifts to the processing operation in ACT 10 explained above.

Consequently, in ACT 10, the printer CPU 61 determines whether the count value of the first counter 641 is the default value “3”. Here, since the count value of the first counter 641 is “1”, in ACT 11, the count value of the first counter 641 is updated from “1” to “2”. At time t13 when the regular interval elapsed, in ACT 12, the printer CPU 61 determines whether synchronization of the polygon mirror motor 43a was detected. In this case as well, the printer CPU 61 determines that synchronization was not detected and shifts to the processing operation in ACT 10.

Similarly, in ACT 10, the printer CPU 61 determines whether the count value of the first counter 641 is the default value “3”. Here, since the count value of the first counter 641 is “2”, in ACT 11, the count value of the first counter 641 is updated from “2” to “3”. At time t14 when the regular interval elapsed, in ACT 12, the printer CPU 61 determines whether synchronization of the polygon mirror motor 43a was detected. In this case as well, the printer CPU 61 determines that synchronization was not detected and shifts to the processing operation in ACT 10.

In this case, since the count value of the first counter 641 is “3”, in ACT 10, the printer CPU 61 determines that the count value of the first counter 641 is the default value “3”. Based on the determination that the count value of the first counter 641 is “3” (YES in ACT 10), in ACT 13, the printer CPU 61 stops the operation of the printer 2.

In ACT 14, the printer CPU 61 notifies a motor abnormality to the system CPU 51. Then, the printer CPU 61 ends the operation. The system CPU 51 receiving the notification of the motor abnormality displays, on the display unit 4a of the operation panel 4, the fact that the polygon mirror motor 43a broke down and printing cannot be performed. The user viewing the display can request a maintenance and inspection company to perform repairing. The system CPU 51 may notify the motor abnormality to the server apparatus 300 with the external interface 56. Consequently, the server apparatus 300 can arrange repairing of the image forming apparatus 100 with the serviceperson terminal 400.

As explained above, after the start of the polygon mirror motor 43a, the printer CPU 61 detects a rotation synchronous signal of the polygon mirror motor 43a and, if determining that the rotating speed of the polygon mirror motor 43a reached the target rotating speed range TRR, thereafter detects the rotation synchronous signal at the regular interval. The printer CPU 61 causes the first counter 641, which is a rotation abnormality counter, to count a continuous number of times of a situation in which the rotation synchronous signal was not successfully detected in the regular interval and, if the count value reached a preset default value, determines that an abnormality such as failure occurred in the polygon mirror motor 43a and ends the operation of the polygon mirror motor 43a and the operation of the printer CPU 61.

Note that, as the failure of the polygon mirror motor 43a, there is also a pattern in which the rotation suddenly stops and is locked. Even if such failure occurs, as in the failure pattern illustrated in FIG. 10, at the stage when the count value of the first counter 641 reaches the default value “3”, the printer CPU 61 can stop the operation of the printer 2 in ACT 13 and notify a motor abnormality to the system CPU 51 in ACT 14.

Further, concerning a rotation failure of the polygon mirror motor 43a, there is also the following pattern. That is, the rotation of the polygon mirror motor 43a repeatedly temporarily becomes unstable and returns to a stable state, a rotation characteristic is gradually deteriorated, a return time to the stable state increases, and the rotation finally cannot return to the stable state and falls into a state in which it is finally determined that the polygon mirror motor 43a broke down as illustrated in FIG. 10. In this embodiment, a state in which the rotation characteristic is gradually deteriorated and the rotation is unstable before the state in which it is finally determined that the polygon mirror motor 43a broke down is detected as a sign of failure as explained below.

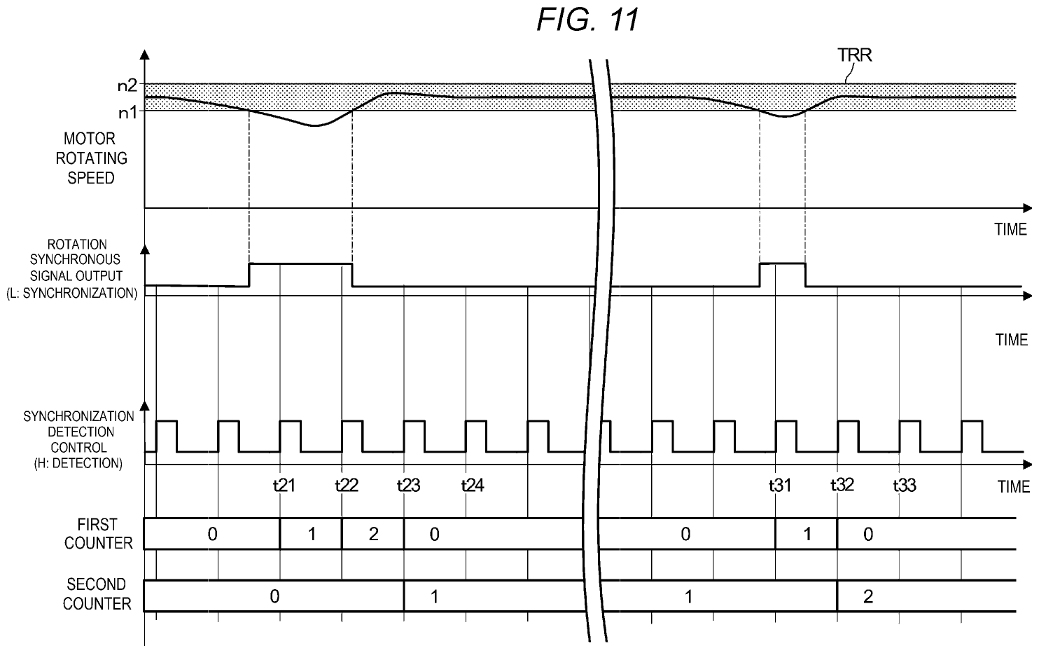

FIG. 11 is a time chart illustrating a relation among motor rotating speed, a rotation synchronous signal, synchronization detection signal control, a count value of the first counter 641, and a count value of the second counter 642 in the case in which the polygon mirror motor 43a does not completely break down but there is a sign of failure. In this case, in a situation in which the polygon mirror motor 43a is rotating in the target rotating speed range TRR, if the rotating speed decreases and deviates from the target rotating speed range TRR, the rotating speed is repeatedly controlled to be returned to the target rotating speed range TRR and returns to the target rotating speed range TRR.

Accordingly, as illustrated in FIG. 11, at time t21 that is the first synchronization determination timing after the rotating speed of the polygon mirror motor 43a decreases and deviates from the target rotating speed range TRR and the rotation synchronous signal changes to the high state, the printer CPU 61 determines that synchronization is not detected.

Based on the determination that synchronization is not detected (YES in ACT 8), as explained above, in ACT 10, the printer CPU 61 determines whether the count value of the first counter 641 of the nonvolatile memory 64 is a default value, in this example, “3”. Here, since the count value of the first counter 641 is “0” as an initial value, in ACT 11, the count value of the first counter 641 is updated from “0” to “1”.

At time t22 when a regular interval elapsed, in ACT 12, the printer CPU 61 determines whether synchronization of the polygon mirror motor 43a was detected. At this time, as illustrated in FIG. 11, it is attempted to set the polygon mirror motor 43a in the target rotating speed range TRR by rotating speed control but the rotating speed did not reach the target rotating speed range TRR yet. Therefore, the rotation synchronous signal remains in the high state. Accordingly, the printer CPU 61 determines that synchronization is not detected.

Based on the determination that synchronization is not detected (NO in ACT 12), the printer CPU 61 shifts to the processing operation in ACT 10 explained above. Consequently, in ACT 10, the printer CPU 61 determines whether the count value of the first counter 641 is the default value “3”. Here, since the count value of the first counter 641 is “1”, in ACT 11, the count value of the first counter 641 is updated from “1” to “2”.

At time t23 when the regular interval elapsed, in ACT 12, the printer CPU 61 determines whether synchronization of the polygon mirror motor 43a was detected. At this time, as illustrated in FIG. 11, if the rotating speed of the polygon mirror motor 43a returns to the target rotating speed range TRR, the rotation synchronous signal is in the low state and synchronization is detected.

Based on the determination that synchronization was detected (YES in ACT 12), in ACT 15, the printer CPU 61 resets the count value of the first counter 641 to “0”.

In ACT 16, the printer CPU 61 increments the count value of the second counter 642 of the nonvolatile memory 64. The count value of the second counter 642 is “0” as an initial value. Accordingly, at a point in time of the time t23, the count value of the second counter 642 is updated from “0” to “1”.

In ACT 17, the printer CPU 61 determines whether the count value of the second counter 642 is a specified number of times. If the specified number of times is too large, the polygon mirror motor 43a falls into a complete failure status before a failure sign is detected. Therefore, the specified number of times is preferably set to several times to ten or more times. The specified number of times is stored in the nonvolatile memory 64 as setting information for each of the image forming apparatuses 100. If the count value of the second counter 642 is “1”, the printer CPU 61 determines that the count value of the second counter 642 is not the specified number of times. Based on the determination (NO in ACT 17), the printer CPU 61 shifts to the processing operation in ACT 8 explained above.

In the example illustrated in FIG. 11, at a point in time of time t24 when a time set as the next regular interval comes, the rotating speed of the polygon mirror motor 43a returns to the target rotating speed range TRR. Therefore, at the time t24 and subsequent points in time, the printer CPU 61 repeats the processing operations in ACT 8 and ACT 9 explained above. Accordingly, the count value of the first counter 641 is maintained at “0” and the count value of the second counter 642 is maintained at “2”.

In the example illustrated in FIG. 11, after any time elapses, since the rotating speed of the polygon mirror motor 43a deviates from the target rotating speed range TRR and returns to the target rotating speed range TRR again, the rotation synchronous signal temporarily changes to the high state.

If synchronization determination is performed at t31 that is timing when the rotation synchronous signal changes to the high state, the printer CPU 61 determines that synchronization is not detected. Based on the determination that synchronization is not detected (YES in ACT 8), in ACT 10, the printer CPU 61 determines whether the count value of the first counter 641 of the nonvolatile memory 64 is a default value, in this example, “3”. Here, since the count value of the first counter 641 is reset to “0”, in ACT 11, the count value of the first counter 641 is updated from “0” to “1”. At a point in time of the time t31, since no operation for the second counter 642 is performed, the count value of “1” is maintained.

At time t32 when the regular interval elapsed, in ACT 12, the printer CPU 61 determines whether synchronization of the polygon mirror motor 43a was detected. At this time, as illustrated in FIG. 11, the rotating speed of the polygon mirror motor 43a returns to the target rotating speed range TRR and the rotation synchronous signal is in the low state. Accordingly, synchronization is detected.

Based on determination that synchronization was detected (YES in ACT 12), in ACT 15, the printer CPU 61 resets the count value of the first counter 641 to “0”.

In ACT 16, the printer CPU 61 increments the count value of the second counter 642 of the nonvolatile memory 64. In this way, at a point in time of the time t32, the count value of the second counter 642 is updated from “1” to “2”.

In ACT 17, the printer CPU 61 determines whether the count value of the second counter 642 is a specified number of times and, if the count value of the second counter 642 is “2”, determines that the count value is not the specified number of times. Based on the determination (NO in ACT 17), the printer CPU 61 shifts to the processing operation in ACT 8 explained above.

In the example illustrated in FIG. 11, at a point in time of time t33 when a time set as the next regular interval comes and subsequent points in time, the rotating speed of the polygon mirror motor 43a is stable in the target rotating speed range TRR. Therefore, the printer CPU 61 repeats the processing operations in ACT 8 and ACT 9 explained above. Accordingly, the count value of the first counter 641 is maintained at “0” and the count value of the second counter 642 is maintained at “2”.

In this way, at the time of execution of the current printing or subsequent printing, every time the rotating speed temporarily deviates from the target rotating speed range TRR, the count value of the second counter 642 is incremented.

Based on the determination that the count value of the second counter 642 is the specified number of times (YES in ACT 17), in ACT 18, the printer CPU 61 notifies a motor abnormality sign to the system CPU 51. The notification of the motor abnormality sign includes the count value of the second counter 642. Thereafter, the printer CPU 61 shifts to the processing operation in ACT 8 explained above.

The system CPU 51 receiving the notification of the motor abnormality sign displays the count value included in the notification or displays an alert based on the count value on the display unit 4a of the operation panel 4. The user viewing the display can request the maintenance and inspection company to perform inspection. The system CPU 51 may transmit a monitor abnormality sign notification including the count value or alert content to the server apparatus 300 with the external interface 56. Consequently, the server apparatus 300 can arrange inspection of the image forming apparatus 100 with the serviceperson terminal 400.

As explained above, if the rotation synchronous signal of the polygon mirror motor 43a rotating in the target rotating speed range TRR was not successfully detected the number of times (for example, once or twice) less than a continuous number of times (for example, three times) of determining that failure occurred, although a defect occurs in the polygon mirror motor 43a, since the polygon mirror motor 43a is rotating, the printer CPU 61 determines that the polygon mirror motor 43a is in a usable state even if there is a slight defect in an image and continues the printing as it is. However, at this time, the printer CPU 61 increments the count value of the second counter 642 functioning as a motor abnormality possibility counter and stores the count value in the nonvolatile memory 64. In this way, the number of times a temporary synchronization non-detection status occurs can be counted by the second counter 642. If the count value of the second counter 642 reaches the specified number of times, the printer CPU 61 determines that the polygon mirror motor 43a is currently usable but is likely to be in an unusable state sooner or later and provides the count value of the second counter 642 to the system CPU 51. Consequently, the system CPU 51 can directly display the count value or display an alert based on the count value on the display unit 4a of the operation panel 4 and transmit the count value or alert content to the server apparatus 300.

Accordingly, the user viewing the display and the server apparatus 300 receiving the count value or the alert content can arrange repairing of the image forming apparatus 100 with the serviceperson while the image forming apparatus 100 can be still used. Consequently, it is possible to prevent the image forming apparatus 100 from becoming unusable because of complete failure of the polygon mirror motor 43a or reduce a period in which the image forming apparatus 100 is unusable until repairing even if the image forming apparatus 100 breaks down before repairing is actually performed.

As explained above, after the polygon mirror motor 43a is started and shifts to the steady rotation in the target rotating speed range TRR, the printer CPU 61 of the image forming apparatus 100 according to this embodiment, which scans laser light on the photoconductive drums 30 with the polygon mirror 43 rotated by the polygon mirror motor 43a and performs image formation, determines, repeatedly at the regular interval, whether the rotating speed of the polygon mirror motor 43a is within the target rotating speed range TRR. In this way, the printer CPU 61 functions as the first determining unit. If the rotating speed of the polygon mirror motor 43a is outside the target rotating speed range TRR the specified continuous number of times, the printer CPU 61 determines that failure of the polygon mirror motor 43a occurred. In this way, the printer CPU 61 functions as the second determining unit. If the rotating speed of the polygon mirror motor 43a returns from the outside of the target rotating speed range TRR to within the target rotating speed range TRR the number of times less than the specified continuous number of times, the printer CPU 61 stores the number of times, for example, in the nonvolatile memory 64. In this way, the printer CPU 61 and the nonvolatile memory 64 function as the storage unit.

As explained above, in the image forming apparatus 100 according to this embodiment, after the polygon mirror motor 43a is started and shifts to the steady rotation in the target rotating speed range TRR, the printer CPU 61 checks, repeatedly at the regular interval, whether the rotating speed of the polygon mirror motor 43a is within the target rotating speed range TRR and, if the rotating speed returns to within the target rotating speed range TRR the number of times less than the specified continuous number of times even if the rotating speed deviates from the target rotating speed range TRR, stores the number of times in the nonvolatile memory 64. Accordingly, by checking the number of times stored in the nonvolatile memory 64, it is possible to discriminate presence or absence of occurrence possibility of an abnormality such as failure of the polygon mirror motor 43a at a point in time before the polygon mirror motor 43a completely breaks down. Consequently, if the abnormality occurrence possibility is present, it is possible to request inspection of the polygon mirror motor 43a. It is possible to prevent the image forming apparatus 100 from becoming unusable because of complete failure of the polygon mirror motor 43a or reduce a period in which the image forming apparatus 100 is unusable until repairing even if the image forming apparatus 100 breaks down before repairing is actually performed.

The image forming apparatus 100 according to this embodiment includes the second counter 642 that counts the number of times the rotating speed of the polygon mirror motor 43a returns from the outside of the target rotating speed range TRR to within the target rotating speed range TRR less than the specified continuous number of times.

Accordingly, the image forming apparatus 100 according to this embodiment can easily store, by using the second counter 642, the number of times the rotating speed of the polygon mirror motor 43a deviates from the target rotating speed range TRR and returns to within the target rotating speed range TRR less than the specified continuous number of times.

The printer CPU 61 counts, with the first counter 641, the number of times of determination that the rotating speed of the polygon mirror motor 43a is outside the target rotating speed range TRR, resets the first counter 641 according to the determination that the rotating speed of the polygon mirror motor 43a is within the target rotating speed range TRR, and, if the number of times counted by the first counter 641 reaches the specified continuous number of times, determines that failure of the polygon mirror motor 43a occurred.

Accordingly, the image forming apparatus 100 can easily count, using the first counter 641, a continuous number of times the rotating speed of the polygon mirror motor 43a is in the target rotating speed range TRR and can easily determine failure of the polygon mirror motor 43a based on the counted continuous number of times.

Note that, in this case, the image forming apparatus 100 includes the second counter 642 that counts the number of times of resetting the first counter 641.

Accordingly, by counting the number of times of resetting the first counter 641 using the second counter 642, the image forming apparatus 100 according to this embodiment can easily store the number of times the rotating speed of the polygon mirror motor 43a deviates from the target rotating speed range TRR and returns to within the target rotating speed range TRR less than the specified continuous number of times.

The polygon mirror motor 43a outputs a rotation synchronous signal if rotating within the target rotating speed range TRR. The printer CPU 61 detects the rotation synchronous signal at the regular interval to determine whether the rotating speed of the polygon mirror motor 43a is within the target rotating speed range TRR.

Accordingly, by using the rotation synchronous signal from the polygon mirror motor 43a, the image forming apparatus 100 according to this embodiment is capable of easily determining whether the rotating speed of the polygon mirror motor 43a is within the target rotating speed range TRR.

The image forming apparatus 100 according to this embodiment further includes the display unit 4a that presents the number of times stored in the nonvolatile memory 64. In this way, the display unit 4a functions as the presenting unit.

Accordingly, the image forming apparatus 100 according to this embodiment can cause the user to check the number of times the rotating speed of the polygon mirror motor 43a deviates from the target rotating speed range TRR and returns to within the target rotating speed range TRR less than the specified continuous number of times and easily discriminate whether to request inspection of the polygon mirror motor 43a. The serviceperson requested to perform inspection is capable of easily checking the number of times.

Alternatively, the image forming apparatus 100 according to this embodiment further includes the external interface 56 that transmits the number of times stored in the nonvolatile memory 64 to the server apparatus 300 via the external network 600. In this way, the external interface 56 functions as the communication unit.

Accordingly, since the image forming apparatus 100 according to this embodiment transmits, to the server apparatus 300, the number of times the rotating speed of the polygon mirror motor 43a deviates from the target rotating speed range TRR and returns to within the target rotating speed range TRR less than the specified continuous number of times, the server apparatus 300 is capable of discriminating presence or absence of occurrence possibility of an abnormality such as failure of the polygon mirror motor 43a based on the number of times.

The embodiment is explained above. However, embodiments are not limited to the embodiment.

For example, in the embodiment explained above, the transmission of the count value of the second counter 642 to the server apparatus 300 in ACT 1 is carried out at the time power-on time and if a request from the server apparatus 300 is received. However, the count value may not be transmitted at the power-on time. Instead, the image forming apparatus 100 may transmit the count value at any specified time, for example, the image forming apparatus 100 may start a timer at a specified time at night or the like and transmit the count value to the server apparatus 300 at the specified time. The image forming apparatus 100 may transmit the count value based on another condition other than the time, for example, every time the count value of the second counter 642 is incremented or every time the count value of the second counter 642 increases by a fixed number of times from the last transmission time.

In the embodiment explained above, the image forming apparatus 100 includes the two processors, that is, the system CPU 51 and the printer CPU 61. However, it goes without saying that the various processing operations of the image forming apparatus 100 may be implemented by one processor.

In the embodiment explained above, the control program is stored beforehand in the nonvolatile memory 64 of the printer 2 of the image forming apparatus 100. Concerning this point, a control program transferred separately from the image forming apparatus 100 may be written in a writable storage device included in the image forming apparatus 100 according to operation of an administrator or the like. The transfer of the control programs and the like can be performed by storing the control programs and the like in a removable computer-readable storage medium or by communication via a network. A form of the computer-readable storage medium does not matter if the computer-readable storage medium can store programs and can be read by a device like a CD-ROM, a memory card, and the like.

Besides, the several embodiments are explained above. However, the embodiments are presented as examples and are not intended to limit the scope of the disclosure. These new embodiments can be implemented in other various forms. Various omissions, substitutions, and changes can be made without departing from the gist of the disclosure. The embodiments and modifications thereof are included in the scope of the disclosure and included in the scope of the disclosure described in the claims and equivalents of the disclosure.

What is claimed is:

1. An image forming apparatus configured to scan light on a photoconductive body with a mirror rotated by a mirror motor and perform image formation, the image forming apparatus comprising:
at least one processor configured to:
after the mirror motor is started and shifts to steady rotation in a target rotating speed range, determine, repeatedly at a regular interval, whether rotating speed of the mirror motor is within the target rotating speed range;
when the rotating speed of the mirror motor is outside the target rotating speed range a specified continuous number of times, determine that failure of the mirror motor occurred; and
a storage configured to, when the rotating speed of the mirror motor returns from outside of the target rotating speed range to within the target rotating speed range a number of times less than the specified continuous number of times, store the number of times.

2. The apparatus according to claim 1, wherein the storage includes a counter configured to count a number of times the rotating speed of the mirror motor returns from outside of the target rotating speed range to within the target rotating speed range less than the specified continuous number of times.

3. The apparatus according to claim 1, wherein the at least one processor is configured to:
count, with a first counter, a number of times of the determination by the at least one processor that the rotating speed of the mirror motor is outside the target rotating speed range, and
reset the first counter according to the determination by the at least one processor that the rotating speed of the mirror motor is within the target rotating speed range and, when the number of times counted by the first counter reaches the specified continuous number of times, determine that failure of the mirror motor occurred.

4. The apparatus according to claim 3, wherein the storage includes a second counter configured to count a number of times of reset of the first counter.

5. The apparatus according to claim 1, wherein
the motor outputs a rotation synchronous signal when rotating within the target rotating speed range, and
the at least one processor is configured to detect the rotation synchronous signal at the regular interval to determine whether the rotating speed of the mirror motor is within the target rotating speed range.

6. The apparatus according to claim 1, further comprising a communication circuit configured to transmit the number of times stored by the storage unit to a server apparatus via a network.

7. The apparatus according to claim 1, wherein the mirror comprises a polygon mirror.

8. The apparatus according to claim 7, wherein the mirror motor comprises a polygon mirror motor.

9. The apparatus according to claim 1, wherein the photoconductive body comprises a photoconductive drum.

10. The apparatus according to claim 1, wherein the light scanned on the photoconductive body is laser light.

11. A method of operating an image forming apparatus, the image forming apparatus configured to scan laser light on a photoconductive body with a mirror rotated by a mirror motor and perform image formation, the method comprising:
after the mirror motor is started and shifts to steady rotation in a target rotating speed range, determining, repeatedly at a regular interval, whether rotating speed of the mirror motor is within the target rotating speed range;
when the rotating speed of the mirror motor is outside the target rotating speed range a specified continuous number of times, determining that failure of the mirror motor occurred; and
when the rotating speed of the mirror motor returns from outside of the target rotating speed range to within the target rotating speed range a number of times less than the specified continuous number of times, storing the number of times.

12. The method according to claim 11, further comprising counting a number of times the rotating speed of the mirror motor returns from outside of the target rotating speed range to within the target rotating speed range less than the specified continuous number of times.

13. The method according to claim 11, further comprising:
counting a number of times the determination that the rotating speed of the mirror motor is outside the target rotating speed range, and
resetting the counting according to the determination that the rotating speed of the mirror motor is within the target rotating speed range and, when the number of times counted reaches the specified continuous number of times, determining that failure of the mirror motor occurred.

14. The method according to claim 13, further comprising counting a number of times of reset of the counting.

15. The method according to claim 11, further comprising:
outputting a rotation synchronous signal when rotating within the target rotating speed range; and
detecting the rotation synchronous signal at the regular interval to determine whether the rotating speed of the mirror motor is within the target rotating speed range.

16. The method according to claim 11, further comprising transmitting the number of times stored to a server apparatus via a network.

17. A non-transitive computer readable medium storing instructions for performing a method of operating an image forming apparatus, the image forming apparatus configured to scan laser light on a photoconductive body with a mirror rotated by a mirror motor and perform image formation, the instructions when execute, cause the method to be performed, the method comprising:
after the mirror motor is started and shifts to steady rotation in a target rotating speed range, determining, repeatedly at a regular interval, whether rotating speed of the mirror motor is within the target rotating speed range;
when the rotating speed of the mirror motor is outside the target rotating speed range a specified continuous number of times, determining that failure of the mirror motor occurred; and
when the rotating speed of the mirror motor returns from outside of the target rotating speed range to within the target rotating speed range a number of times less than the specified continuous number of times, storing the number of times.

18. The computer readable medium according to claim 17, the method further comprising counting a number of times the rotating speed of the mirror motor returns from outside of the target rotating speed range to within the target rotating speed range less than the specified continuous number of times.

19. The computer readable medium according to claim 17, the method further comprising:
counting a number of times the determination that the rotating speed of the mirror motor is outside the target rotating speed range, and
resetting the counting according to the determination that the rotating speed of the mirror motor is within the target rotating speed range and, when the number of times counted reaches the specified continuous number of times, determining that failure of the mirror motor occurred.

20. The computer readable medium according to claim 19, the method further comprising counting a number of times of reset of the counting.
